(19) United States
(12) Patent Application Publication
(10) Pub. No.: US 2024/0389798 A1
(43) Pub. Date: Nov. 28, 2024

(54) Receiving Vessel for a Kitchen Appliance, Kitchen Appliance and Method of Operating a Kitchen Appliance

(71) Applicant: Vorwerk & Co. Interholding GmbH, Wuppertal (DE)

(72) Inventors: Nils Beckmann, Remscheid (DE); Volker Wahle, Hamminkeln (DE)

(21) Appl. No.: 18/673,467

(22) Filed: May 24, 2024

(30) Foreign Application Priority Data
May 25, 2023 (EP) 23175359.1

(51) Int. Cl. A47J 43/046; A47J 43/07; B01F 35/22; B01F 101/00; H04B 5/24; H04B 5/79

(52) U.S. Cl. CPC A47J 43/046; B01F 35/2205; H04B 5/24; H04B 5/79; A47J 43/0716; B01F 2101/1805

(57) ABSTRACT

A receiving vessel for a kitchen appliance with a wall forming a receiving space and with a component attached to the wall. A first antenna for wireless communication is arranged at the component, that a second antenna for wireless communication is arranged at the component. A first adapting network is arranged at the component, wherein the first adapting network is connected to the first antenna and to the second antenna. The first adapting network is configured to adapt characteristics of the first antenna and/or the second antenna for transmitting a signal. Also described are a system and a method.

### CROSS-REFERENCE TO RELATED APPLICATION

This application claims priority to European Patent Application No. 23175359.1 filed May 25, 2023, the disclosure of which is hereby incorporated by reference in its entirety.

### BACKGROUND OF THE INVENTION

### Field of the Invention

The present invention relates to a receiving vessel for a kitchen appliance with a wall forming a receiving space and with a component attached to the wall. The present invention further relates to a kitchen appliance with such a receiving vessel and with a base appliance, as well as to a method for operating such a kitchen appliance.

### DESCRIPTION OF RELATED ART

Modern kitchen appliances are often supplied with a variety of accessories designed to better assist the user in different food preparation processes. Although these accessories may help to improve the quality of the preparation results, their number increases the complexity of using the kitchen appliance for the user. It is already known from the prior art that accessories can be automatically recognised by the kitchen appliance itself, for example by appropriately designed sensors at the base appliance.

In order to offer the widest possible range of applications, receiving vessels for kitchen appliances are generally designed with a material composition that is temperature-resistant for boiling to frozen foods. It is also usually desirable for the receiving vessel to be dishwasher-safe. Receiving vessels made of stainless steel or at least with a relatively high proportion of metal are therefore available on the market. It has been found that the material of the receiving vessel can hinder or at least interfere with automatic accessory recognition using technologies such as RFID (Radio Frequency Identification) or NFC (Near Field Communication).

To circumvent this, the state of the art proposes accessory detection by closing electrical contacts, which, however, has the disadvantage of open electrical contact surfaces.

### SUMMARY OF THE INVENTION

Against this background, the present invention is based on the task of providing a receiving vessel, a kitchen appliance and a method with increased user-friendliness. In particular, the present invention is based on the task of improving accessory recognition in kitchen appliances.

According to the invention, the aforementioned task is solved with a receiving vessel for a kitchen appliance with a wall forming a receiving space and with a component attached to the wall, in that a first antenna for wireless communication is arranged at the component, wherein a second antenna for wireless communication is arranged at the component, in that a first adapting network is arranged at the component, the first adapting network being connected to the first antenna and to the second antenna, and in that the adapting network for adapting properties of the first antenna and of the second antenna is arranged at the component, wherein a first adapting network is arranged at the component, the first adapting network being connected to the first antenna and to the second antenna, and the adapting network being configured for adapting properties of the first antenna and/or of the second antenna for transmitting a signal.

With this receiving vessel, the obstacle represented by a material composition of the wall that shields against electromagnetic waves can be overcome by transmitting a signal required for automatic accessory recognition, for example, through the component or through the handle of the receiving vessel. In other words, the receiving vessel according to the invention has means that enable the signal to be rerouted around the shielding wall via the handle. Furthermore, by providing the adapting network, different antenna elements can be installed in the first antenna and in the second antenna, whereby these can exchange signals with each other despite having different properties.

Furthermore, the design of the antennas for wireless communication with, for example, a communication module of a kitchen appliance can increase the robustness of the receiving vessel against liquids and external influences. Accordingly, the user-friendliness of the receiving vessel is improved, particularly during food preparation processes and also during cleaning processes.

The aforementioned problem is further solved according to the invention with a kitchen appliance with a base appliance and with a receiving vessel, in particular with a receiving vessel as described above, the receiving vessel having a wall and a component, wherein a first communication module is provided on the base appliance, wherein a first antenna and a second antenna are arranged at the component of the receiving vessel, the first antenna and the second antenna being connected by cable, and wherein the first communication module of the base appliance and the first antenna of the receiving vessel are configured for wireless communication with one another.

Accordingly, the second antenna can be used to wirelessly detect or receive a signal, for example from an accessory or a smartphone, at a position that is outside the range of the base appliance and then transmit the signal safely and easily, for example by cable connection, to the first antenna arranged within detection range of the base appliance. The signal can then be transmitted wirelessly by the second antenna to the communication module of the base appliance.

The aforementioned task is further solved according to the invention by a method for operating a kitchen appliance, in particular a kitchen appliance described above, in which a base appliance is provided with a first communication module configured for wireless communication, in which a receiving vessel is provided with a component, with a first antenna, with a second antenna and with an adapting network, wherein the first antenna, the second antenna and the adapting network are arranged at the component, in which the first communication module of the base appliance and the first antenna of the receiving vessel are arranged within mutual range, in which a signal is received by the second antenna and forwarded to the adapting network, in which properties of the signal are adapted by the adapting network to the properties of the first antenna, and in which the signal with adapted properties is transmitted wirelessly by the first antenna to the first communication module of the base appliance.

The process achieves the same advantages as the receiving vessel and the kitchen appliance.

A base appliance within the meaning of the present invention is preferably designed as a base for the use of a receiving vessel and at least one accessory. The base appliance has a housing in which an electric motor for driving accessories is arranged.

The receiving vessel has a wall that at least partially surrounds a receiving space for holding food. Preferably, the wall comprises a base and walls that are formed in one piece or in several pieces or as separate parts. Furthermore, the wall or the base or a double base of the receiving vessel can be designed in such a way that it forms an interface for mechanical connection with the housing of the base appliance. In addition, a heater can be provided on the base of the receiving vessel for heating food held in the receiving vessel.

An accessory is understood to be any part designed to interact with the base appliance. The term “interaction” includes, among other things, the actions from the list: Connecting, coupling, mounting, fitting, attaching, mounting and the like. In particular, an accessory is designed to extend the function of the base appliance, for example as a cutting, stirring, cooking, weighing, cooking, steaming or covering unit.

A component is attached to the wall. The component can, for example, be designed as a handling part in the form of one or more handles, as an element for thermal and/or electrical insulation of the receiving vessel, as an enclosure for the receiving vessel, or as an additional component without any other special function. Alternatively or additionally, the component can be removably connected to the wall of the receiving vessel, for example by means of a magnetic, clamping or latching element. This allows the receiving vessel to be easily removed, for example for cleaning purposes. Alternatively, the component can be firmly connected to the wall of the receiving vessel in order to increase the robustness of the receiving vessel.

In addition, the first antenna and the second antenna can be integrated into the component. This protects the antennas from external influences, such as during a cleaning process or mechanical stresses.

The component, when in the form of a handling part, is preferably intended to simplify gripping the receiving vessel. An example of a handling part is a handle that is connected to the wall of the receiving vessel. The handling part can be made of a thermally insulating material in order to reduce the risk of burns to a user or a kitchen work surface.

A first antenna and a second antenna are provided at the component of the receiving vessel. Both antennas are preferably connected to each other via a cable connection, for example via the first adapting network, and are each configured for wireless communication with other communication modules or means. For example, the first antenna of the receiving vessel in the context of the kitchen appliance is configured to communicate wirelessly with the first communication module of the base appliance.

An antenna according to the present disclosure preferably comprises at least one antenna element, which may be passive or active. In addition, an antenna according to the present disclosure may comprise a transceiver, a transmitter and or further electronic components which are configured for signal processing, conversion, transmission, adaptation and/or evaluation. The transceiver is preferably designed to extract at least one piece of information from a modulated signal received by the antenna element.

Furthermore, the receiving vessel is preferably designed in such a way that a signal can be applied in parallel, in particular almost simultaneously, to the first antenna and to the second antenna. This offers a third antenna with a transceiver, for example a cover element provided for the receiving vessel, the possibility of analysing the signal at a position spatially remote from the receiving vessel.

In the present case, the term “communication” is understood to mean a transfer of signals that can be carriers of information data. Such information can be, for example, a status of an accessory, a status of a food item, a time, information about a preparation parameter, user information, a measured value from a sensor or other information, although this list is not exhaustive. In addition, signals that are communicated can be carriers of energy that can be used to power electronic components, for example.

The base appliance has a first communication module configured for wireless communication and the receiving vessel has a first antenna configured for wireless communication. The first communication module and the first antenna are configured to communicate with each other or to exchange signals with each other wirelessly. For this purpose, the first communication module can have an antenna element and a transceiver which, in co-operation, are configured to emit an excitation signal, for example a high-frequency alternating electromagnetic field, on the one hand and to receive and analyse a modulated response signal on the other. The first antenna has a first antenna element and is preferably configured to receive an excitation signal from the first communication module of the base appliance, modulate it and output it as a modulated response signal. In this way, a signal that carries information can be transmitted wirelessly, in particular contactlessly, between the base appliance and the receiving vessel.

At least one adapting network is provided at the receiving vessel, in particular on the component of the receiving vessel, which is configured to adapt the properties of a signal received by the first antenna element to the properties of the second antenna element. In addition or alternatively, the adapting network can be configured to adapt the properties of a signal received by the second antenna element to the properties of the first antenna element. For example, the adapting network may comprise capacitors, coils and/or resistors and may be configured such that a (suitable) total impedance is formed for an antenna element of the first antenna or the second antenna.

Preferably, the communication partners, for example the first antenna, the second antenna and the first communication module, each have an adapting network. As a result, signals or properties of signals can be adapted to the properties of differently designed communication partners or antenna elements by the respective adapting networks. Differences between antenna elements can thus be equalised in order to enable transmission of the adapted signals. In addition, the individual adapting networks can be configured to adapt the properties of a signal to the requirements of downstream processing elements or electronic components, for example to subsequently analyse the signals in measured values or to generate power on the basis of the signal.

An adapting network according to the present disclosure is preferably configured to statically or dynamically adjust properties of an antenna or an antenna element and/or a signal. For this purpose, the first adapting network and/or further provided adapting networks may comprise electronic components which altogether represent a variable capacitance and/or impedance.

Various embodiments of the receiving vessel, the kitchen appliance and the method are described below, whereby the individual embodiments each apply independently of one another to the receiving vessel, the kitchen appliance and the method. Furthermore, the individual embodiments can be combined with one another as desired.

In one embodiment of the receiving vessel, the first antenna comprises a near-field communication transceiver and the second antenna comprises a passive near-field communication transmitter.

This means that the receiving vessel can be realised with elements already available on the market, whereby these components are relatively inexpensive. In addition, near-field communication elements offer the advantage of a relatively short range of the detection field, so that data transmission can be guaranteed as reliable and robust.

Alternatively or additionally, the first antenna of the receiving vessel can be configured for inductive energy transmission or be based on a proprietary standard for power supply. In particular, the second antenna can be configured for wireless communication with a near-field communication element or with an inductive communication element of a smartphone.

Furthermore, by designing the antennas of the receiving vessel as near-field communication transceivers or near-field communication transmitters, a bidirectional communication connection can be established with, for example, the base appliance, with accessories and/or with other elements such as a smartphone.

In one embodiment of the receiving vessel, the first adapting network is configured to adapt characteristics of a signal received by the second antenna to the characteristics of the first antenna.

Accordingly, signals can be transmitted both from the first antenna to the second antenna and in the opposite direction, i.e. from the second antenna to the first antenna.

In the context of the kitchen appliance, such a receiving vessel enables bidirectional communication between the accessory and the base appliance. For example, values that have been recorded by a sensor on the receiving vessel can be analysed centrally on the base appliance and used for the overall control of the kitchen appliance, whereby the control also includes functions that are to be performed using the receiving vessel.

In one embodiment of the receiving vessel, a second adapting network and a power supply are provided, the second adapting network is configured to adapt characteristics of a signal received by the first antenna for further processing by the power supply, and the power supply is adapted to generate power from the signal received wirelessly by the first antenna with adapted characteristics.

In one embodiment of the receiving vessel, the power supply is connected to a microprocessor and is configured to supply power to the microprocessor. Alternatively or additionally, the power supply is connected to the transceiver and is configured to supply power to the transceiver.

In a corresponding embodiment of the method, a signal is transmitted wirelessly from the first communication module of the base appliance to the first antenna of the receiving vessel, current is generated by a power supply of the first antenna from the transmitted signal, and a transceiver and/or a microprocessor of the receiving vessel is supplied with the generated current.

These embodiments of the receiving vessel and the method each offer the advantage of a power supply for the purpose of data communication or evaluation. This can be used, for example, to supply power to an active part of the first antenna or sensors that are provided at the receiving vessel and are connected to the processor. This makes it possible to dispense with electrical connections or contacts as well as additional energy supply means such as batteries or accumulators on the receiving vessel as a whole, while still increasing user-friendliness through data collection, transmission and evaluation.

In this way, electronic components attached to the receiving vessel can be supplied with power and at the same time a cable connection for this power supply to the kitchen appliance can be dispensed with. Accordingly, the receiving vessel and also the kitchen appliance can be designed without a cable connection or electrical contacts, which is advantageous for an application in connection with food or for cleaning the receiving vessel or the kitchen appliance. In addition, a power supply or the use of so-called active components enables a general expansion of the possible functions of the receiving vessel and the kitchen appliance.

The power supply can, for example, have a rectifier and a voltage regulator.

In one embodiment of the receiving vessel, a transceiver and a microprocessor are provided, wherein the transceiver is connected to the second adapting network and to the microprocessor. The second adapting network is configured to adapt characteristics of a signal received by the first antenna for further processing by the transceiver, and the transceiver is configured to adapt the signal for further processing by the microprocessor. The transceiver is configured to adapt a signal output by the microprocessor for further processing by the transceiver. The second adapting network is adapted to adapt the microprocessor signal adapted by the microprocessor for transmission by the first antenna.

This allows data received at the first antenna to be processed by the microprocessor and/or data output by the microprocessor to be sent by the first antenna, for example to the base appliance.

Sensors can be provided at the receiving vessel, for example in the form of a magnetic sensor, Hall sensor, temperature sensor or others. In particular, a magnetic sensor can be used to detect an accessory status, such as an accessory type, by detecting the magnetic polarisation.

Preferably, the power supply is configured to supply the at least one sensor with power.

In particular, the microprocessor can be configured to process a measurement signal output by the at least one sensor into an information signal, and the first antenna can be configured to transmit an information signal output by the microprocessor wirelessly, in particular to a communication module of the base appliance of the kitchen appliance.

The base appliance can react depending on the result of a detection by means of the at least one sensor, for example in the form of a selection of at least one preparation parameter for a preparation process. Specifically, it is conceivable that a preparation process is automatically triggered after detection of the intended placement of a lid on the receiving vessel.

In a corresponding embodiment of the method, a sensor arranged at the receiving vessel is supplied with power by the power supply. Furthermore, a value for a state of a part of the kitchen appliance and/or a value for a state of a foodstuff held by the receiving vessel can be detected by the sensor, the at least one detected value is transmitted to the first antenna of the receiving vessel, the at least one detected value is analysed by the transceiver and the result of the analysis is transmitted wirelessly to the first communication module of the base appliance by the first antenna of the receiving vessel.

In this way, information can be transferred from the receiving vessel to the base appliance and also from the base appliance to the receiving vessel. For example, values that have been recorded by a sensor at the receiving vessel can be analysed centrally on the base appliance and used for the overall control of the kitchen appliance, whereby the control also includes functions that are to be performed using the receiving vessel.

In one embodiment of the receiving vessel, the receiving vessel has a connecting portion configured to mechanically connect to a base appliance of the kitchen appliance, and the first antenna is disposed on a portion of the component closest to the connecting portion.

This embodiment enables a compact design of the receiving vessel. In particular, the connecting section for the mechanical connection of the receiving vessel to the base appliance and the first antenna for signal transmission between the receiving vessel and the base appliance are used in parallel. Due to the physical proximity of the connecting section of the receiving vessel to the base appliance required for the mechanical connection, it is ensured that the first antenna of the receiving vessel is arranged as close as possible to the base appliance in a mounted state in order to improve the communication conditions.

In one embodiment of the receiving vessel, the wall has an upwardly directed opening so that the receiving space formed by the wall is open at the top, and the second antenna is arranged at a portion of the component which is arranged closest to the upwardly directed opening of the wall.

In a corresponding embodiment of the kitchen appliance, the wall of the receiving vessel has an upwardly directed opening, so that the receiving space formed by the wall is open at the top. In addition, a cover part formed to cover the upwardly directed opening of the wall of the receiving vessel is provided, a communication unit configured for wireless communication with the second antenna of the receiving vessel is arranged at the cover part, and the second antenna of the receiving vessel is arranged at a portion of the component which is arranged closest to the upwardly directed opening of the wall.

In this way, proximity of the second antenna of the receiving vessel to the communication unit on the cover part is ensured, which is particularly advantageous in the case of near-field communication. If the second antenna of the receiving vessel is configured for communication with a smartphone, the position proposed here on the component is easily accessible and therefore also convenient for the user.

In one embodiment of the kitchen appliance, a first accessory with a first communication unit is provided and the second antenna of the receiving vessel and the first communication unit of the first accessory are configured for wireless communication.

Accordingly, signals can be exchanged within the system including the base appliance, the receiving vessel and the first accessory, and there is no need for hard-to-clean plug elements.

In a further embodiment of the kitchen appliance, the first accessory has a second communication unit and an adapting network. The first communication unit, the adapting network and the second communication unit are connected by cable. The adapting network of the first accessory is configured to adapt a signal received by the second communication unit to properties of the first communication unit. A second accessory with a communication part is provided for use in the receiving space of the receiving vessel, and the second communication unit of the first accessory is configured to communicate wirelessly with a communication part of the second accessory.

Accordingly, an accessory that is within range of the second communication unit can be detected by it and the result of the detection can be transmitted to the first communication module of the base appliance via the antennas of the receiving vessel, if necessary for corresponding centralized control. Overall, accessories arranged in the receiving space of the receiving vessel can be detected and automatically recognised despite the shielding material composition of the wall of the receiving vessel.

In one embodiment of the receiving vessel, the component is essentially made of a material that is at least partially permeable to electromagnetic waves and the first antenna and the second antenna are integrated in the component.

Accordingly, the receiving vessel, in particular the component, can be designed to be airtight and watertight. This allows the receiving vessel to be cleaned easily. In addition, signal transmission between the first antenna of the receiving vessel and the first communication module of the base appliance can take place unhindered.

Preferably, the component has a housing made of a material that is permeable to electromagnetic waves, for example plastic, and the first antenna and the second antenna are arranged in the housing.

In addition, the wall of the receiving vessel can be at least partially made of a material that is at least partially impermeable to electromagnetic waves. The permeability of a material to electromagnetic waves or fields depends on the conductivity and permeability of the material and on the frequency of the waves or the field. For electromagnetic waves or fields emitted by a near-field communication transceiver, stainless steel is essentially impermeable or predominantly attenuates these waves. In the context of the present invention, stainless steel has been found to be substantially impermeable to electromagnetic waves with a frequency of about 13.56 MHz. The substantial impermeability of the material was tested on areas of the wall of the receiving vessel that do not have a penetrating opening. Preferably, the material is also suitable for holding food hygienically, particularly at elevated temperatures that regularly occur during food preparation.

In one embodiment of the receiving vessel, the component is designed as a handle element, an insulating element, a removable accessory, an additional component or a combination thereof.

Thus, in addition to the repeater function for transmitting signals, the component can also have one or more other functions, for example by acting as a handle or insulation. In addition, the component can simply be designed as an additional component that has no other function apart from those involving the antennas.

In one embodiment of the kitchen appliance, a connecting element designed for arrangement in a penetrating opening in the wall of the receiving vessel is provided, the connecting element has a first communication part and a second communication part, which are connected to each other by cable. Furthermore, a second communication module is provided on the base appliance and the second communication module of the base appliance and the first communication part of the connecting element are configured for wireless communication with each other. In addition, the second communication part of the connecting element is configured for wireless communication, in particular for wireless communication with a communication part of an accessory intended for use in the receiving space of the receiving vessel.

This allows an accessory to be recognised easily and confidently despite the shielding material composition of the wall of the receiving vessel. In other words, the connecting element can be used as a repeating unit or relay station between the base appliance and the accessory. In combination with the accessory detection via the cover part and also via the component, the entire spatial detection field is extended so that accessories can be detected or recognised more reliably.

In addition, a receiving vessel that already has a penetrating opening in the wall, for example to enable an accessory to be connected to the drive of the base appliance, can continue to be used. Overall, the invention allows existing kitchen appliances to be easily converted and at the same time increases user-friendliness.

The wall of the receiving vessel has a penetrating opening. Preferably, the penetrating opening is formed in the base, in particular if the receiving vessel is intended for connection to the base appliance in the base area. Alternatively, the penetrating opening can be provided on a panel of the wall. In this case, the sealing requirements for foodstuffs held in the receiving space of the receiving vessel are less stringent, making the kitchen appliance easier to manufacture.

A connecting element within the meaning of the present invention is an element which is suitable for ensuring a communication connection between the accessory and the base appliance. It is envisaged that the connecting element is designed to be arranged in the penetrating opening of the wall of the receiving vessel. In this way, the connecting element can transmit a signal, in particular in the form of an electromagnetic wave, which has been emitted by the second communication module on the base appliance on one side of the wall, through the wall and forward it to the accessory. This also applies in the opposite direction, i.e. for a signal that is transmitted from the accessory in the direction of the second communication module of the base appliance.

For arrangement in the penetrating opening of the wall of the receiving vessel, the connecting element preferably has a base body with a shape that is adapted, at least in sections, to the shape of the penetrating opening. A sealing element can be provided between the base body of the connecting element and the inner wall of the opening.

In one embodiment of the kitchen appliance, a controller with a first operating mode, with a second operating mode and with a third operating mode is provided, wherein in the first operating mode the controller analyses signals from the first communication module, wherein in the second operating mode the controller analyses signals from the second communication module, and wherein in the third operating mode the controller analyses signals from the first communication module and signals from the second communication module together.

In a corresponding embodiment of the method, a signal is received by the first communication module of the base appliance and/or a signal is received by a second communication module provided at the base appliance and configured for wireless communication. Furthermore, a controller of the base appliance is operated in a first operating mode, in which the signal received by the first communication module is analysed, in a second operating mode, in which the signal received by the second communication module is analysed, or in a third operating mode, in which the signal received by the first communication module and the signal received by the second communication module are analysed.

This allows accessory recognition to be taken into account when controlling the kitchen appliance, with accessory recognition being carried out either on the basis of a signal transmitted via the connecting element or on the basis of a signal transmitted via the component of the receiving vessel.

In particular, a switchover from one operating mode to another can be provided. This switchover can take place by detecting a user input with a switchover command and the controller switching to the corresponding operating mode in response to the user input. A switching element can be provided on the component for this purpose.

Alternatively or additionally, switching can take place automatically depending on the origin of the signal, i.e. depending on whether a signal was received from the first communication module or from the second communication module.

### BRIEF DESCRIPTION OF THE DRAWINGS

Further features and advantages of the receiving vessel and the kitchen appliance and the methods are shown in the following description of embodiments, with reference being made to the attached drawing.

In the drawing,

FIG. 1 shows a first example of a receiving vessel;

FIG. 2 shows a simplified block diagram for a power supply of a receiving vessel;

FIG. 3 shows a first example of a kitchen appliance;

FIG. 4 shows a simplified block diagram for components of the kitchen appliance shown in FIG. 3 that are involved in signal transmission;

FIG. 5 shows a second example of a kitchen appliance;

FIG. 6 shows a simplified block diagram for components of the kitchen appliance shown in FIG. 5 that are involved in signal transmission;

FIG. 7 shows a third example of a kitchen appliance;

FIG. 8 shows a simplified block diagram for components of the receiving vessel of the kitchen appliance in FIG. 5 that are involved in signal transmission,

FIG. 9 shows a flowchart for a method of operating a kitchen appliance, and

FIG. 10 shows a block diagram for an adapting network.

### DESCRIPTION OF THE INVENTION

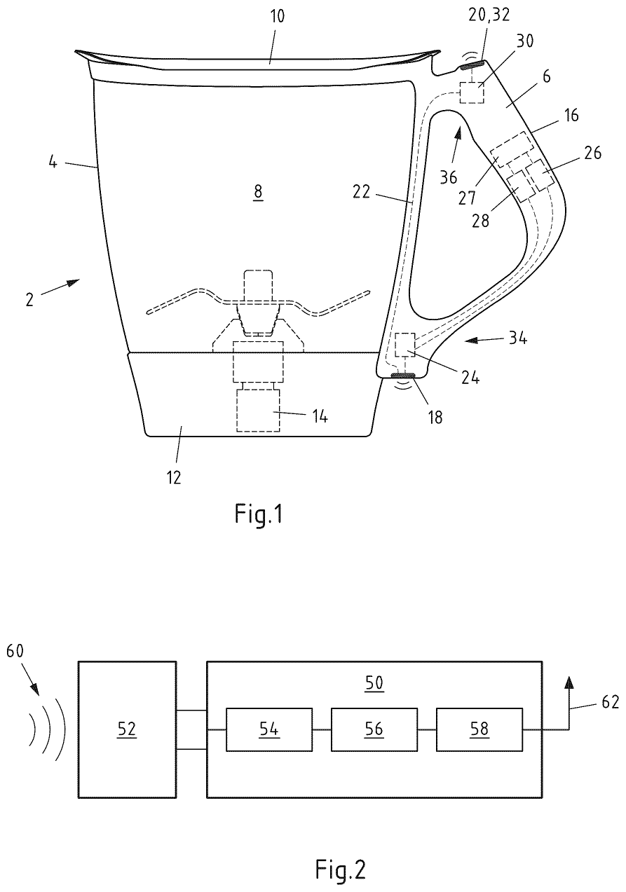

FIG. 1 shows a first embodiment of a receiving vessel 2. The receiving vessel 2 has a wall 4 and a component 6. The wall 4 forms a receiving space 8 for receiving foodstuffs and has an upwardly directed opening 10, so that the receiving space 8 formed by the wall 4 is open at the top. The wall 4 has a base 12 on which a connecting section 14 is provided for mechanical connection to a base appliance of a kitchen appliance. In addition, the wall 4 is essentially made of stainless steel, which predominantly prevents contactless signal transmission through the wall 4.

The component 6 is designed as a handle and is mechanically connected to the wall 4. Furthermore, the component 6 is attached to the wall 4 in such a way that it is arranged outside the receiving space 8 formed by the wall 4. The component 6 has a housing 16 which is essentially made of plastic and whose main direction of extension connects the edge of the upwardly directed opening 10 of the wall 4 and the connecting section 14 for the mechanical connection to a base appliance.

A first antenna 18 and a second antenna 20 are provided at component 6. Both are configured for wireless communication with other means of communication.

The first antenna 18 is connected to an adapting network 24, a near field communication transceiver 26 having a microprocessor 27 and a power supply 28. The power supply 28 is configured to generate power from a signal received wirelessly by the first antenna 18 and to supply power to the microprocessor 27. The second antenna 20 has a passive near-field communication transmitter 32 and is connected to an adapting network 30.

The first antenna 18 is connected to the adapting network 30 via a cable connection 22.

The first antenna 18 is arranged at the portion 34 of the component 6 which is arranged closest to the connecting portion 14. Furthermore, the second antenna 20 is arranged at the portion 36 of the component 6 which is arranged closest to the opening 10 of the wall 4. Both the first antenna 18 and the second antenna 20 are arranged at the housing 16 of the component 6 and are thus integrated in the component 6.

FIG. 2 shows a simplified block diagram for a power supply 50 of a receiving vessel. The power supply 50 is configured to generate a current from a signal received wirelessly or contactlessly. For this purpose, the power supply 50 is connected to an adapting network 52 with an interconnection of resistors, capacitors and inductors not shown. The power supply 50 has a filter 54 for electromagnetic compatibility or a so-called “EMC filter”, a rectifier 56 and a voltage regulator 58.

In an intended use and when a radio frequency signal, for example a near field communication signal, is applied, characteristics of an antenna connected to the adapting network 52 are adapted to enable a signal to be received. The received signal 60 is then transmitted to the power supply 50, which then converts the signal 62 into a current and outputs it to power other components.

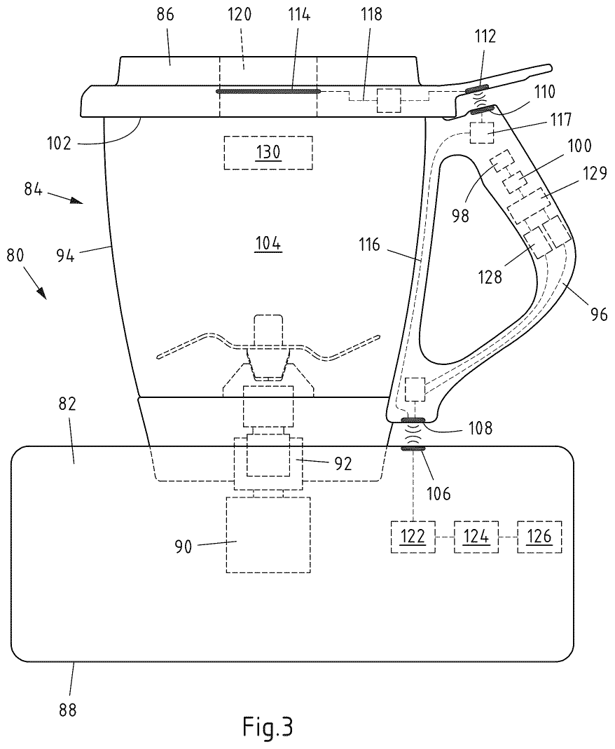

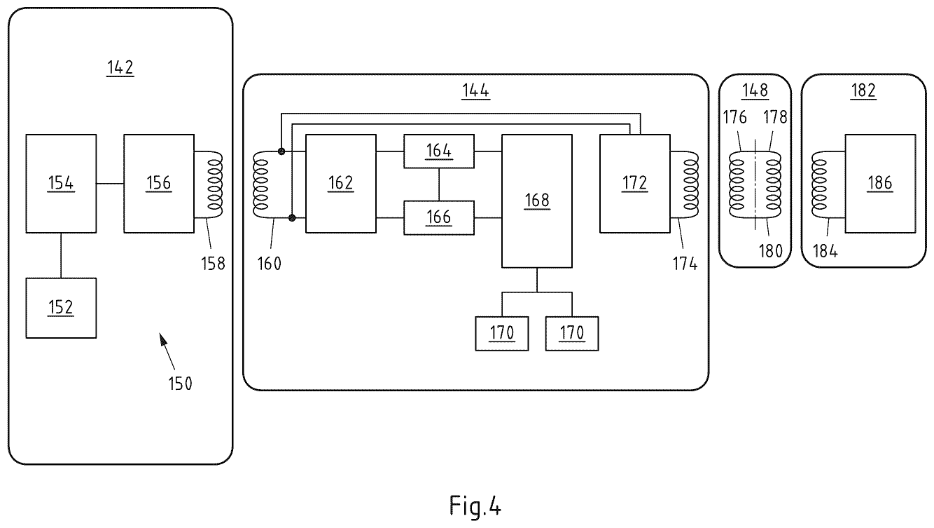

FIG. 3 shows a first example of a kitchen appliance 80 with a base appliance 82, with a receiving vessel 84 and with an accessory designed as a cover part 86.

The base appliance 82 has a housing 88, an electric motor 90 and a connecting section 92 for mechanical connection to the receiving vessel 84. The receiving vessel 84 has a wall 94 and a component 96 with the same features and components as the receiving vessel 84 of FIG. 1. Here, two additional sensors 98, 100 are provided on the receiving vessel 84. The wall 94 of the receiving vessel 84 also has an upwardly directed opening 102 here, so that the receiving space 104 formed by the wall 94 is open at the top. The cover part 86 is designed to cover the upwardly directed opening 102 of the wall 94 of the receiving vessel 84 and thus to close off the receiving space 104.

The kitchen appliance 80 has a communication system comprising: a first communication module 106 on the base appliance 82, a first antenna 108 and a second antenna 110 on the component 96 of the receiving vessel 84, and a first communication unit 112 and a second communication unit 114 on the cover portion 86.

The first communication module 106 at the base appliance 82 and the first antenna 108 at the component 96 are configured to communicate with each other wirelessly. The first antenna 108 is connected to an adapting network 117, which in turn is connected to the second antenna 110 at the component 96 via a cable connection 116. The second antenna 110 on the component 96 and the first communication unit 112 on the cover portion 86 are configured to communicate with each other wirelessly. The first communication unit 112 is in turn connected to the second communication unit 114 on the cover part 86 via a cable connection 118. In the present embodiment example, the second communication unit 114 is arranged at a centred opening 120 of the cover part 86.

The first communication module 106 comprises an adapting network 122, a transceiver 124 and a microprocessor 126.

The first communication module 106 and the first antenna 108 are each arranged at the base appliance 82 and on the component 96 of the receiving vessel 84 in such a way that they are within mutual signal transmission range in an intended mounted state of the kitchen appliance 80.

In addition, the second antenna 110 and the first communication unit 112 are each arranged at the component 96 on the cover part 86 in such a way that they are within mutual signal transmission range in an intended mounted state of the kitchen appliance 80.

A power supply 128 of the first antenna 108 of the receiving vessel 84 is configured to supply power to the microprocessor 129 and the sensors 98, 100.

In an intended use, the second communication unit 114 detects an accessory 130 that is located in the receiving space 104 of the receiving vessel 84 and within range of the second communication unit 114, and transmits a corresponding signal via the communication system to the base appliance 82. The base appliance 82 analyses the signal and recognises the accessory 130 when applicable.

Thus, the first antenna 108 on the component 96 of the receiving vessel 84 is configured for at least four functions. A first function is to forward a wirelessly received signal to the second antenna 110 of the receiving vessel 84 via the cable connection 116. In a second function, the first antenna 108 forwards a signal received from the second antenna 110 of the receiving vessel 84 to the first communication module 106 of the base appliance 82. The first function and the second function together correspond to a capability for bidirectional communication with the first communication module 106 of the base appliance 82. According to a third function, the received signal can be forwarded to other components, for example the microprocessor 129 and possibly the sensors 98, 100. The fourth function is obtained by the first antenna 108 generating a current from a received signal with the power supply 128 and making the generated current available to further components, for example the microprocessor 129 and the sensors 98, 100.

The second antenna 110 on the component 96 can be used for at least two functions. In a first function, the second antenna 110 on the component 96 serves a user as an interface for data transmission to the base appliance 82. A user can bring accessories equipped with RFID transponders (tags) or a smartphone with an NFC interface into the reading range of the second antenna 110, where the information content of the transponder is detected. By forwarding the information to the base appliance 82 via the component 96, the base appliance 82 can recognise the transponder and perform actions associated with the transponder information.

In addition, and in a second function, the second antenna 110 on the component 96 serves as a so-called “gateway” when the cover part 86 is recognised. If the cover part 86 is fitted, then the second antenna 110 on the component 96 couples with the first communication unit 112 by adapting properties of the first communication unit with the aid of a capacitor of the first communication unit. In this way, the capacitor acts as an adapting network. The first communication unit 112 of the cover part 86 is within the range of the second antenna 110 in the component 96 of the receiving vessel 84 when it is attached to the receiving vessel 84 as intended.

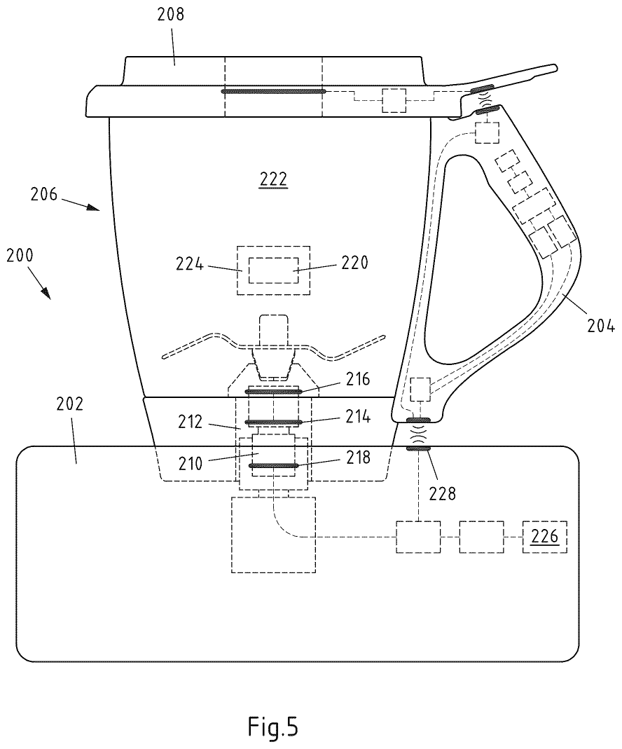

FIG. 4 shows a simplified block diagram for components of the kitchen appliance shown in FIG. 3 that are involved in signal transmission. The base appliance, the component 144 of the receiving vessel 146 and the cover part 148 are each shown schematically with a block.

The first communication module 150 of the base appliance 142 has a microprocessor 152, a transceiver 154, an adapting network 156 and a coil-like antenna 158. The microprocessor 152 in the block diagram in FIG. 4 fulfils the same role as the microprocessor 126 from the base appliance in FIG. 3.

a first coil-like antenna 160, an adapting network 162, a power supply 164, a transceiver 166, a microprocessor 168, two sensors 170, a further adapting network 172 and a further coil-like antenna 174 are arranged from left to right and provided at the component 144.

The first coil-like antenna 160 is cable-connected to the adapting network 172, wherein the adapting network 172 is in turn cable-connected to the second coil-like antenna 174. The further coil-like antenna 174 may be used in a similar manner to the passive near-field communication transmitter 32 of FIG. 1.

A first coil-like antenna 176 and a further coil-like antenna 178 are provided on the cover part 148, which are connected to each other via a cable connection 180.

In addition, an accessory 182 with a corresponding block is schematically shown, which has a coil-like antenna 184 and a radio label 186.

FIG. 5 shows a second embodiment example for a kitchen appliance 200 with a base appliance 202, with a receiving vessel 206 having a component 204 and with a cover part 208. This embodiment example is based on the principle of the kitchen appliance 200 shown in FIG. 3. In addition to the features explained in connection with the embodiment example of FIG. 3, an extension of the communication system is provided in FIG. 5 at a connecting element 210, which is designed for arrangement in a penetrating opening 212 of the wall of the receiving vessel 206. In the present embodiment example, the connecting element 210 is designed as a cutting unit with a cutter shaft.

The connecting element 210 has a first communication part 214 and a second communication part 216, which are connected to each other by cable. A second communication module 218 is provided on the base appliance 202. The second communication module 218 of the base appliance 202 and the first communication part 214 of the connecting element 210 are configured for wireless communication with one another.

The second communication part 216 of the connecting element 210 is configured for wireless communication with a communication part 220 of an accessory 224 intended for use in the receiving space 222 of the receiving vessel 206.

In addition, a controller 226 is provided on the base appliance 202, which controller is designed as a microprocessor with an active part. The controller 226 is provided with a first operating mode, with a second operating mode and with a third operating mode. In the first operating mode, the controller 226 analyses signals from the first communication module 228, in the second operating mode, the controller 226 analyses signals from the second communication module 218, and in the third operating mode, the controller 226 analyses signals from the first communication module 228 and signals from the second communication module 218 together. The controller 226 is configured to automatically switch from one operating mode to another depending on whether and by which the first communication module 228 or the second communication module 218 receives a signal.

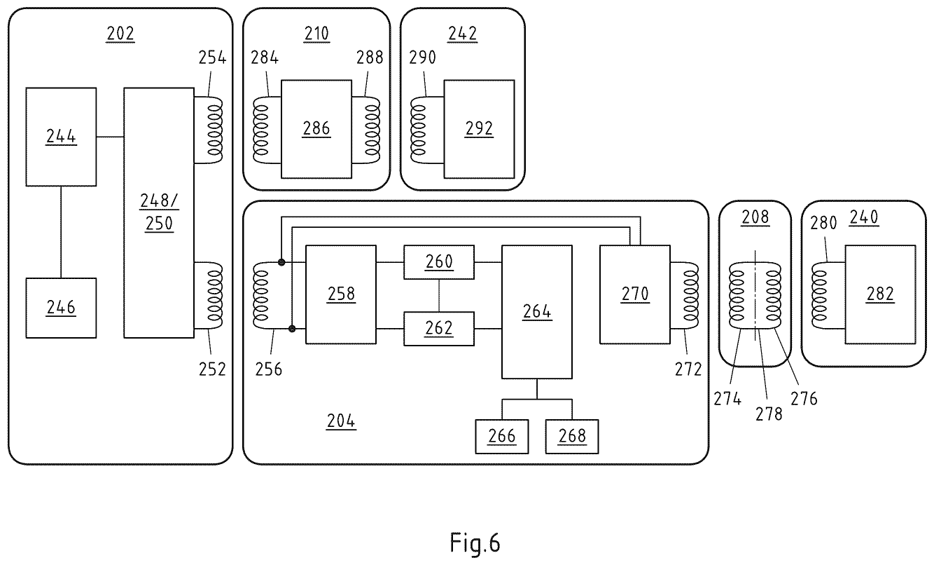

FIG. 6 shows a simplified block diagram for components of the kitchen appliance 200 of FIG. 5, which are involved in a signal transmission. The base appliance 202, the component 204 of the receiving vessel 206, the cover part 208, a first accessory 240, the connecting element 210 and a further accessory 242 are shown schematically as blocks.

The base appliance 202 comprises a transceiver 244, a microprocessor 246, an adapting network 248, a switching element 250, a first coil-like antenna 252 and a second coil-like antenna 254.

The component 204 comprises, shown from left to right, a first coil-like antenna 256 configured to communicate wirelessly with the first coil-like antenna 252 of the base appliance 202, an adapting network 258, a power supply 260, a transceiver 262, a microprocessor 264, two sensors 266, 268, a further adapting network 270 and a further coil-like antenna 272. The first coil-like antenna 256 is connected to the adapting network 270, which in turn is connected to the second coil-like antenna 272. A first coil-like antenna 274 and a further coil-like antenna 276 are provided on the cover portion 208, which are connected to each other via a cable connection 278. The first accessory 240 again has a coil-like antenna 280 and a radio tag 282.

The connecting element 210 is provided with a first coil-like antenna 284 adapted to communicate wirelessly with the second coil-like antenna 254 of the base appliance 202, with an adapting network 286 and with a further coil-like antenna 288. The second accessory 242 again comprises a coil-like antenna 290 for communicating with the further antenna 288 of the connecting element 210 and a radio tag 292.

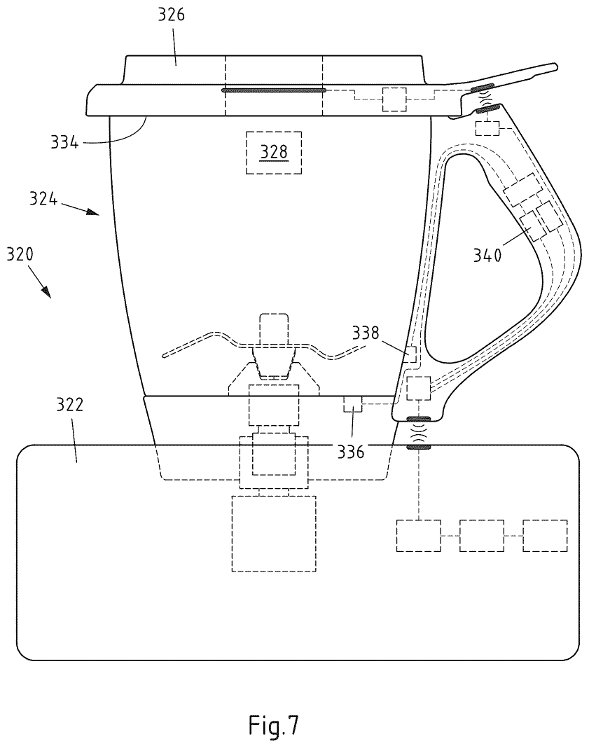

FIG. 7 shows a third embodiment example for a kitchen appliance 320 with a base appliance 322, with a receiving vessel 324, with a cover part 326 and with an accessory 328. The kitchen appliance 320 is designed similarly to the embodiment example of FIG. 3, wherein temperature sensors 336, 338 are provided at the base and at the wall of the receiving vessel 324.

The power supply 340 supplies power to the microprocessor, whereby the microprocessor is in turn connected to the temperature sensors 336, 338, which are arranged at the receiving vessel 324. By connecting the microprocessor to the sensors, power can be supplied to the sensors. Alternatively or in addition to sensors that can be supplied with power by the power supply 340, the system can have at least one sensor whose energy budget is independent of the power supply 340.

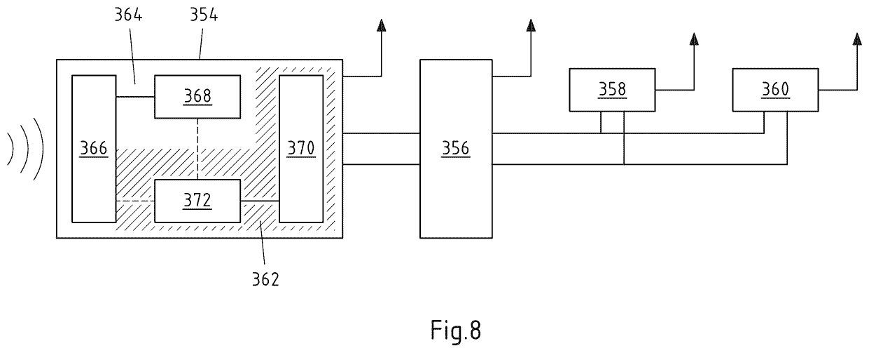

FIG. 8 shows a simplified block diagram for components of the receiving vessel of the kitchen appliance from FIG. 5 or from FIG. 7, which are involved in signal transmission. A transceiver 354, a microprocessor 356 and sensors 358, 360 are shown schematically with blocks. The transceiver 354 has an active part 362 (not hatched) and a passive part 364 (hatched area including components arranged in this area).

The passive part 364 in turn has a near-field communication element 366 and a non-volatile data memory 368 or so-called “EEPROM”. Unique identifiers, configuration data and/or other information are stored in the data memory 368. The near-field communication element 366 is configured for communication in accordance with the “NFC Forum Type 2 Tag” standard and does not require a separate external supply voltage.

The active part 362 has a so-called “I²C interface” 370 and a volatile data memory 372 (“SRAM”). The data memory 372 can be overwritten via the I²C interface 370, whereby an externally generated supply voltage is required. In the context of the invention, this supply is provided by the power supply of the first antenna of the receiving vessel, for example as in the embodiment example shown in FIG. 2.

The volatile data memory 372 (“SRAM”) can be overwritten via the near-field communication element 366 in two variants.

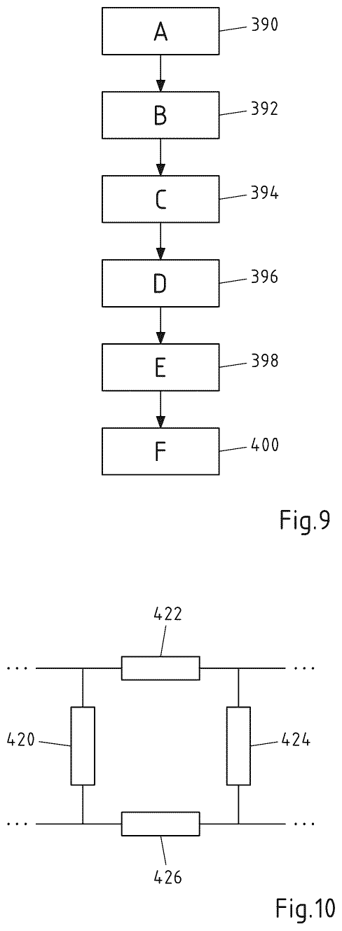

FIG. 9 shows a flow diagram for a method of operating a kitchen appliance.

In a first method step A 390, a base appliance with a first communication module configured for wireless communication is provided.

Simultaneously or subsequently, in a step B 392, a receiving vessel is provided with a component and with a first antenna arranged at the component and configured for wireless communication.

At step C 394, the communication module of the base appliance and the first antenna of the receiving vessel are arranged within mutual range.

Subsequently, and in step D 396, a signal is transmitted from the first communication module of the base appliance to the first antenna of the receiving vessel, and then, in step E 398, current is generated from the transmitted signal by the first antenna of the receiving vessel.

In step F 400, the generated current is used to supply an active part of the first antenna of the receiving vessel.

As an alternative or additional method step, a further signal can be transmitted from the first communication module of the base appliance to the first antenna of the receiving vessel and at least one piece of information can be extracted from the received signal for data communication.

FIG. 10 shows a block diagram for an adapting network, wherein four impedances 420, 422, 424 and 426 are shown. These impedances represent the behaviour of electronic components of an adapting network for a receiving vessel or for a kitchen appliance, the impedance values being selected as a function of the characteristics of the associated antenna or antenna element.

1. A receiving vessel for a kitchen appliance
with a wall forming a receiving space and
with a component attached to the wall, wherein
a first antenna for wireless communication is arranged at the component,
a second antenna for wireless communication is arranged at the component,
a first adapting network is arranged at the component,
wherein the first adapting network is connected to the first antenna and to the second antenna, and
wherein the first adapting network is configured to adapt characteristics of the first antenna and/or the second antenna for transmitting a signal.

2. The receiving vessel according to claim 1, wherein
the first antenna comprises a near field communication transceiver, and
the second antenna comprises a passive near-field communication transmitter.

3. The receiving vessel according to claim 1, wherein
the first adapting network is configured to adapt characteristics of a signal received by the second antenna to the characteristics of the first antenna.

4. The receiving vessel according to claim 1, wherein
a second adapting network and a power supply are provided,
the second adapting network is configured to adjust characteristics of a signal received by the first antenna for further processing by the power supply, and
the power supply is configured to generate power with adapted characteristics from the signal received wirelessly by the first antenna.

5. The receiving vessel according to claim 4, wherein
a transceiver and a microprocessor are provided,
wherein the transceiver is connected to the second adapting network and to the microprocessor,
the second adapting network is configured to adapt characteristics of a signal received by the first antenna for further processing by the transceiver, and in that the transceiver is configured to adapt the signal for further processing by the microprocessor, and
the transceiver is configured to adapt a signal output by the microprocessor for further processing by the transceiver, and wherein the second adapting network is configured to adapt the signal from the microprocessor adapted by the microprocessor for transmission by the first antenna.

6. The receiving vessel according to claim 4, wherein
the power supply is connected to the microprocessor and is configured to supply power to the microprocessor,
and/or
the power supply is connected to the transceiver and is configured to supply power to the transceiver.

7. The receiving vessel according to claim 1, wherein
the receiving vessel has a connecting portion which is designed for mechanical connection to a base appliance of the kitchen appliance, and
the first antenna is arranged at a portion of the component which is arranged closest to the connecting portion.

8. The receiving vessel according to claim 1, wherein
the wall has an upwardly directed opening, so that the receiving space formed by the wall is open at the top, and
the second antenna is arranged at a portion of the component which is arranged closest to the upwardly directed opening of the wall.

9. The receiving vessel according to claim 1, wherein
the component is essentially formed from a material which is at least partially permeable to electromagnetic waves, and
the first antenna and the second antenna are integrated in the component.

10. The receiving vessel according to claim 1, wherein
the component is designed as a handle element, an insulating element, a removable accessory, an additional component or a combination thereof.

11. A kitchen appliance
with a base appliance and
with a receiving vessel, in particular with a receiving vessel according to claim 1,
wherein the receiving vessel has a wall and a component, wherein
a first communication module is provided at the base appliance,
a first antenna and a second antenna are arranged at the component of the receiving vessel,
wherein the first antenna and the second antenna are connected by cable, and
the first communication module of the base appliance and the first antenna of the receiving vessel are configured for wireless communication with each other.

12. The kitchen appliance according to claim 11, wherein
a first accessory with a first communication unit is provided, and
the second antenna of the receiving vessel and the first communication unit of the first accessory are configured for wireless communication.

13. The kitchen appliance according to claim 12, wherein
the first accessory comprises a second communication unit and an adapting network,
wherein the first communication unit, the adapting network and the second communication unit are connected by cable,
the adapting network of the first accessory is configured to adapt a signal received by the second communication unit to characteristics of the first communication unit, a second accessory with a communication part is provided for use in the receiving space of the receiving vessel, and
the second communication unit of the first accessory is configured to communicate wirelessly with a communication part of the second accessory.

14. The kitchen appliance according to claim 11, wherein
a connecting element designed for arrangement in a penetrating opening of the wall of the receiving vessel is provided,
the connecting element has a first communication part and a second communication part which are connected to one another by cable,
a second communication module is provided at the base appliance, and
the second communication module of the base appliance and the first communication part of the connecting element are configured for wireless communication with each other, and
the second communication part of the connecting element is configured for wireless communication, in particular for wireless communication with a communication part of an accessory intended for use in the receiving space of the receiving vessel.

15. The kitchen appliance according to claim 14, wherein
a controller with a first operating mode, with a second operating mode and with a third operating mode is provided,
wherein, in the first operating mode, the controller analyses signals from the first communication module,
wherein, in the second operating mode, the controller analyses signals from the second communication module, and
wherein, in the third operating mode, the controller analyses signals from the first communication module and signals from the second communication module together.

16. A method for operating a kitchen appliance, in particular a kitchen appliance according to claim 11,
wherein a base appliance is provided with a first communication module configured for wireless communication,
wherein a receiving vessel is provided with a component, with a first antenna, with a second antenna and with an adapting network,
wherein the first antenna, the second antenna and the adapting network are arranged at the component,
wherein the first communication module of the base appliance and the first antenna of the receiving vessel are arranged in mutual range,
wherein a signal is received by the second antenna and forwarded to the adapting network,
in which characteristics of the signal are adapted by the adapting network to the characteristics of the first antenna, and
wherein the signal with adapted characteristics is transmitted wirelessly by the first antenna to the first communication module of the base appliance.

17. The method according to claim 15,
wherein a signal is transmitted wirelessly from the first communication module of the base appliance to the first antenna of the receiving vessel,
wherein current is generated by a power supply of the first antenna from the transmitted signal, and
wherein a transceiver and/or a microprocessor of the receiving vessel is supplied with the generated current.

18. The method according to claim 16,
wherein a signal is received by the first communication module of the base appliance,
and/or
wherein a signal is received by a second communication module provided on the base appliance and configured for wireless communication, and
wherein a controller of the base appliance is operated in a first operating mode, in which the signal received by the first communication module is analysed, in a second operating mode, in which the signal received by the second communication module is analysed, or in a third operating mode, in which the signal received by the first communication module and the signal received by the second communication module are analysed.
